(19) United States
(12) Patent Application Publication
(10) Pub. No.: US 2018/0082228 A1
(43) Pub. Date: Mar. 22, 2018

(54) DIGITAL PROJECT MANAGEMENT OFFICE

(71) Applicant: Accenture Global Solutions Limited, Dublin (IE)

(72) Inventors: Anupam PANDEY, Bangalore (IN); Sachin KALGUDE, Pune (IN)

(21) Appl. No.: 15/685,808

(22) Filed: Aug. 24, 2017

(30) Foreign Application Priority Data
Sep. 20, 2016 (IN) 201641031996

(51) Int. Cl. G06Q 10/06; H04L 12/24

(52) U.S. Cl. CPC G06Q 10/0631; H04L 41/0813

(57) ABSTRACT

A device may receive requests for a set of project management office (PMO) services that are hosted by a set of enterprise project management (EPM) systems. The requests may include a first request and the first request includes a PMO service identifier. The device may analyze a set of configuration files to identify a configuration file associated with a PMO service of the set of PMO services that is associated with the first request. The configuration file may be associated with the PMO service identifier. The device may execute navigation instructions included in the configuration file to obtain, modify, or create PMO service data by interacting with a server device that hosts the PMO service. The device may perform, using the PMO service data and one or more configuration parameters included in the configuration file, one or more actions associated with delivering the PMO service.

### RELATED APPLICATION

This application claims priority Indian Provisional Patent Application No. 201641031996, filed on Sep. 20, 2016, the content of which is incorporated by reference herein in its entirety.

### BACKGROUND

Enterprise project management (EPM) is a field of business management dedicated to managing and developing projects, people, products, services, and/or the like. An organization may have a project management office (PMO) to define and maintain standards for project management within the organization.

### SUMMARY

According to some possible implementations, a device may receive requests for a set of project management office (PMO) services that are hosted by a set of enterprise project management (EPM) systems. The requests may include a first request and the first request may include a PMO service identifier. Interfaces of the set of PMO services may include different properties. The device may analyze a set of configuration files to identify a configuration file associated with a PMO service of the set of PMO services that is associated with the first request. The configuration file may be associated with the PMO service identifier. The device may execute navigation instructions included in the configuration file to obtain, modify, or create PMO service data by interacting with a server device that hosts the PMO service. The device may perform, using the PMO service data and one or more configuration parameters included in the configuration file, one or more actions associated with delivering the PMO service.

According to some possible implementations, a method may include determining, by a device, to provide a project management office (PMO) service. The PMO service may be one of a set of PMO services that are hosted by a set of enterprise project management (EPM) systems. The interfaces of the PMO services may include different properties. The method may include analyzing, by the device, a set of configuration files to identify a configuration file associated with the PMO service. The method may include executing, by the device, navigation instructions included in the configuration file to obtain, modify, or create PMO service data by interacting with a server device that hosts the PMO service. The method may include performing, by the device and by using the PMO service data and one or more configuration parameters included in the configuration file, one or more actions associated with delivering the PMO service.

According to some possible implementations, a non-transitory computer-readable medium may store one or more instructions that, when executed by the one or more processors, cause the one or more processors to receive requests for a set of project management office (PMO) services that are hosted by a set of enterprise project management (EPM) systems. The requests may include a first request and the first request may include a PMO service identifier. The one or more instructions may cause the one or more processors to analyze a set of configuration files to identify a configuration file associated with a PMO service of the set of PMO services that is associated with the first request. The configuration file may be associated with the PMO service identifier. The one or more instructions may cause the one or more processors to execute navigation instructions included in the configuration file to obtain, modify, or create PMO service data by interacting with a server device that hosts the PMO service. The one or more instructions may cause the one or more processors to perform, using the PMO service data and one or more configuration parameters included in the configuration file, one or more actions associated with delivering the PMO service.

### BRIEF DESCRIPTION OF THE DRAWINGS

FIGS. 1A-1C are diagrams of an overview of an example implementation described herein;

FIG. 2 is a diagram of an example environment in which systems and/or methods, described herein, may be implemented;

FIG. 3 is a diagram of example components of one or more devices of FIG. 2; and

FIG. 4 is a flow chart of an example process for automatically obtaining, modifying, and/or creating PMO service data as part of providing a PMO service and performing one or more actions in furtherance of the PMO service.

### DETAILED DESCRIPTION

The following detailed description of example implementations refers to the accompanying drawings. The same reference numbers in different drawings may identify the same or similar elements.

An organization may use a PMO to define and maintain EPM standards for project management within the organization. To carry out the EPM standards, the PMO may utilize a set of EPM systems that each carry out PMO services relating to particular project management functions of the organization. However, each EPM system and/or PMO service may operate differently, and project managers may need to understand how to operate each EPM system to maintain the EPM standards defined by the PMO. Furthermore, EPM systems operated by project managers may be unable to process and output data fast enough to make real-time decisions, and may be costly to maintain.

Some implementations described herein provide a digital PMO platform to automatically execute a PMO service and perform actions in furtherance of the PMO service. For example, the digital PMO platform may receive, from a user device, a request for a PMO service. In this case, the digital PMO platform may use navigation instructions to automatically obtain, create, and/or modify PMO service data associated with the PMO service. Additionally, the digital PMO platform may perform one or more actions associated with delivering the PMO service.

In this way, the digital PMO platform reduces errors that might otherwise be caused by complex interactions between PMO services, conserves processing resources and/or network resources by providing efficient PMO services (e.g., relative to manual execution of PMO services, of which human error may lead to resources spent on re-execution of PMO services, resources spent on error correction techniques, etc.), conserves memory resources by reducing data redundancy across PMO services, improves business process turnaround time, reduces cost, improves scalability, and/or the like.

Furthermore, the digital PMO platform may receive requests associated with a set of PMO services (e.g., hundreds, thousands, etc.) that are hosted by a set of EPM systems (e.g., tens, hundreds, etc.). As such, the digital PMO platform may process large quantities of data that a human operator may be objectively unable to analyze or process. Moreover, a human operator may struggle to maneuver through interfaces of the EPM systems as each EPM system may utilize a unique interface.

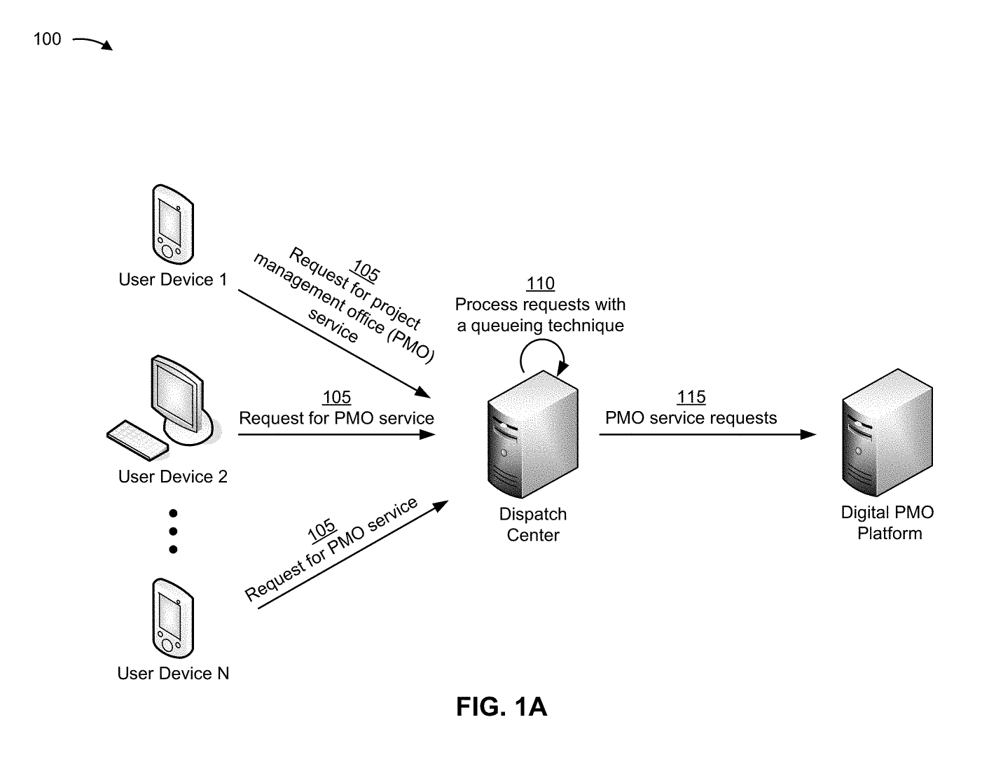

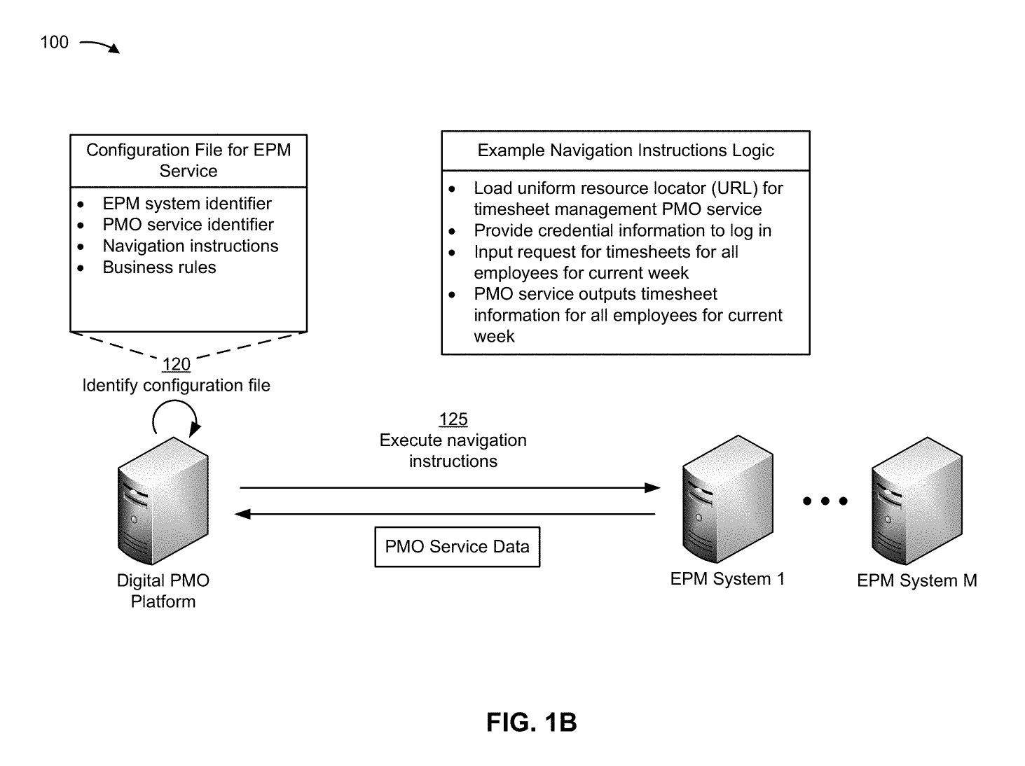

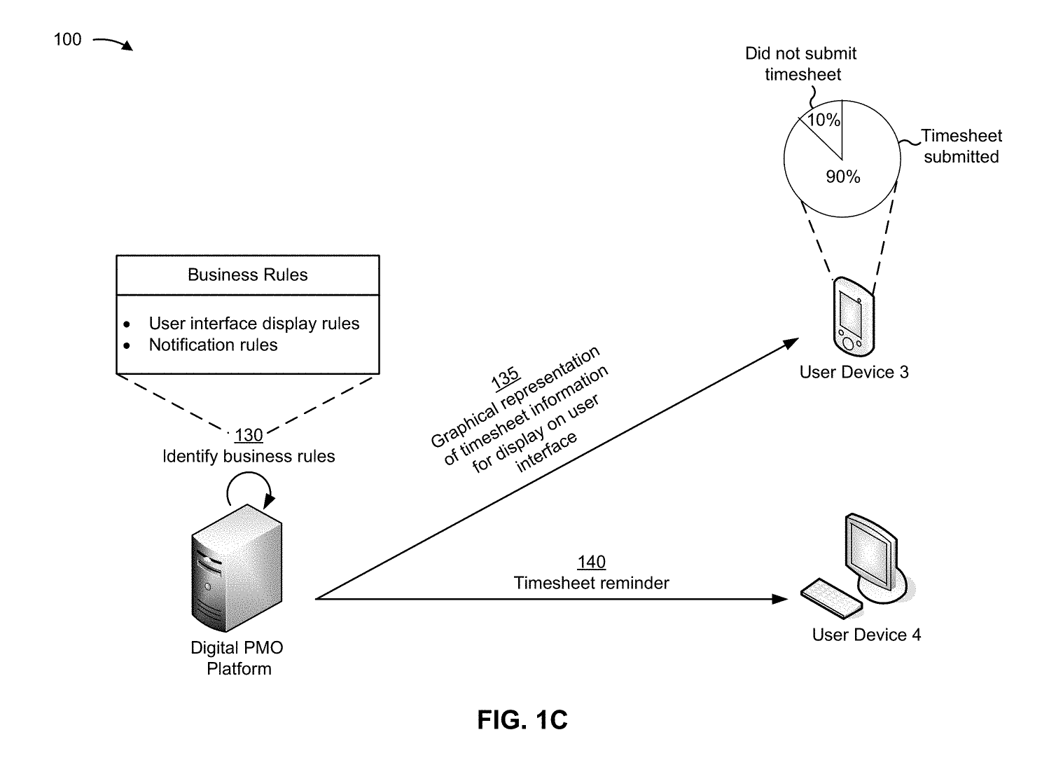

FIGS. 1A-1C are diagrams of an overview of an example implementation 100 described herein. As shown in FIGS. 1A-1C, example implementation 100 may include a digital PMO platform that automatically interacts with one or more EPM systems to deliver a PMO service.

As shown in FIG. 1A, and by reference number 105, a set of user devices (shown as user device 1 through user device N) may provide, to a dispatch center, a set of requests for PMO services. For example, a user may interact with a user interface of a user device to input a request, which may cause the request to be sent to the dispatch center. A PMO service may be a service relating to timesheet management and compliance, risk management, report generation (e.g., a PMO service for generating reports relating to productivity, corrective or preventative actions, billing information, etc.), resource management and planning, and/or the like.

As shown by reference number 110, the dispatch center may process the set of requests for PMO services. For example, the dispatch center may process the set of requests using a queueing technique (e.g., first-in first-out (FIFO), last-in first-out (LIFO), etc.).

As shown by reference number 115, the digital PMO platform may receive the requests for the PMO services from the dispatch center. For example, the dispatch center may identify a request for a PMO service, of the set of requests for PMO services as ready to be output from the queue, and may provide the identified request for the PMO service to the digital PMO platform for further processing. In this case, the request may include an EPM system identifier, a PMO service identifier, information associated with the requested PMO service (e.g., a type or amount of data being requested, a duration for which to receive the data, etc.), and/or the like.

In this way, the digital PMO platform is able to receive a request for a PMO service.

As shown in FIG. 1B, and by reference number 120, the digital PMO platform may identify a configuration file associated with the PMO service. For example, the digital PMO platform may analyze a set of configuration files associated with a set of PMO services, and may identify the configuration file with an EPM system identifier and/or a PMO service identifier that matches the EPM system identifier and/or the PMO service identifier included in the request. Additionally, the configuration file may include navigation instructions identifying automated steps to be used to obtain PMO service data, and a set of business rules that provide instructions associated with delivering the PMO service.

As shown by reference number 125, the digital PMO platform may execute navigation instructions included in the configuration file. For example, the digital PMO platform may execute navigation instructions to obtain PMO service data. PMO service data may include a set of values, metrics, statistics, files, and/or the like, relating to the PMO service.

Shown as an example, the digital PMO platform may execute navigation instructions for a timesheet management PMO service. In this case, the digital PMO platform may use the navigation instructions to load a webpage for a timesheet management PMO service. Additionally, the navigation instructions may include credential information to be able to access the PMO service. Furthermore, the digital PMO platform may input a request for timesheets for all employees for the current week, which may cause the EPM system to output timesheet information for all employees for the current week.

In this way, the digital PMO platform is able to automatically execute navigation instructions to obtain PMO service data.

As shown in FIG. 1C, and by reference number 130, the digital PMO platform may identify the set of business rules included in the configuration file. For example, the set of business rules may include a business rule indicating to display PMO service data in a particular manner (e.g., a particular graphical display), a business rule indicating to provide a reminder or a notification to one or more user devices based on a condition, and/or the like.

As shown by reference number 135, the digital PMO platform may provide a graphical representation of timesheet information for display on a user interface of user device 3. For example, the digital PMO platform may transform the PMO service data to a format capable of being displayed on the user interface of user device 1, and may provide the transformed timesheet information to user device 3.

As an example, assume the digital PMO platform obtains PMO service data that includes a list of users indicating that 9,000 users have submitted a timesheet and 1,000 users have not submitted a timesheet. Further assume a business rule indicates to provide the PMO service data in a graph format (e.g., a pie chart). In this case, the digital PMO platform may transform the list of users to a graphical representation of the data showing that 90% of users have submitted a timesheet and that 10% of users have not submitted a timesheet. This may allow an administrator of an organization to see a visual display of how many users are submitting timesheets in a timely manner.

As shown by reference number 140, the digital PMO platform may provide a timesheet reminder notification to an account associated with user device 4. For example, assume a user associated with user device 4 has yet to submit a timesheet. In this case, the digital PMO platform may provide a reminder notification to aid the user in remembering to submit the timesheet. Additionally, as described further herein, the digital PMO platform may identify a business rule that includes instructions for a forecasting technique, and may allow the digital PMO platform to generate recommendations based on one or more trends associated with the PMO service data and historical PMO service data.

In this way, the digital PMO platform is able to perform one or more actions associated with delivering the PMO service.

As indicated above, FIGS. 1A-1C are provided merely as an example. Other examples are possible and may differ from what was described with regard to FIGS. 1A-1C.

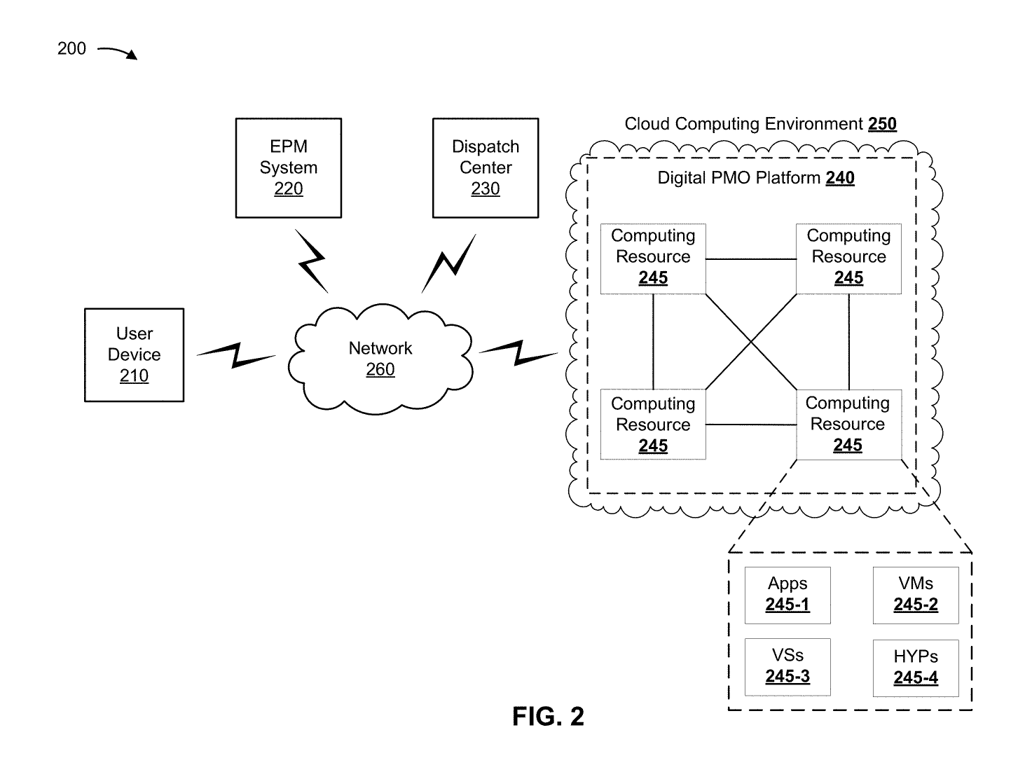

FIG. 2 is a diagram of an example environment 200 in which systems and/or methods, described herein, may be implemented. As shown in FIG. 2, environment 200 may include a user device 210, an EPM system 220, a dispatch center 230, a digital PMO platform 240 hosted within a cloud computing environment 250, and/or a network 260. Devices of environment 200 may interconnect via wired connections, wireless connections, or a combination of wired and wireless connections.

User device 210 includes one or more devices capable of receiving, storing, generating, processing, and/or providing information associated with a PMO service. For example, user device 210 may include a communication and/or computing device, such as a mobile phone (e.g., a smart phone, a radiotelephone, etc.), a laptop computer, a tablet computer, a handheld computer, a gaming device, a wearable communication device (e.g., a smart wristwatch, a pair of smart eyeglasses, etc.), or a similar type of device. In some implementations, user device 210 may provide, to dispatch center 230 and/or digital PMO platform 240, a request for a PMO service. In some implementations, user device 210 may receive, from digital PMO platform 240, information associated with a PMO service.

EPM system 220 includes one or more devices capable of receiving, storing, processing, and/or providing information associated with a PMO service. For example, EPM system 220 may include a server device or a group of server devices. In some implementations, EPM system 220 may receive, from digital PMO platform 240, a request for PMO service data associated with a particular PMO service (e.g., via an interaction with a uniform resource locator (URL) associated with the PMO service). In some implementations, EPM system 220 may provide the PMO service data to digital PMO platform 240. In some implementations, EPM system 220 may receive a request to create, update, or delete a record associated with a PMO service.

Dispatch center 230 includes one or more devices capable of receiving, storing, processing, and/or providing information associated with a request for a PMO service. For example, dispatch center 230 may include a server device or a group of server devices, a network device (e.g., a gateway, a router, etc.), or a similar type of device. In some implementations, dispatch center 230 may receive requests from a set of user devices 210. In some implementations, dispatch center 230 may provide a request for a PMO service to digital PMO platform 240.

Digital PMO platform 240 includes one or more devices capable of receiving, storing, processing, transforming, generating, and/or providing information associated with a PMO service. For example, digital PMO platform 240 may include a server device (e.g., a host server, a web server, an application server, etc.) or a similar device.

In some implementations, digital PMO platform 240 may receive a request for a PMO service from dispatch center 230. In some implementations, digital PMO platform 240 may interact with EPM system 220 to obtain, modify, and/or create PMO service data. In some implementations, digital PMO platform 240 may perform one or more actions associated with delivering the PMO service. For example, digital PMO platform 240 may provide information associated with the PMO service for display on a user interface of user device 210 or a similar type of device. Additionally, or alternatively, digital PMO platform 240 may provide a notification or a reminder associated with the PMO service to user device 210 or a similar type of device.

In some implementations, as shown, digital PMO platform 240 may be hosted in cloud computing environment 250. Notably, while implementations described herein describe digital PMO platform 240 as being hosted in cloud computing environment 250, in some implementations, digital PMO platform 240 may not be cloud-based (i.e., may be implemented outside of a cloud computing environment) or may be partially cloud-based.

Cloud computing environment 250 includes an environment that hosts digital PMO platform 240. Cloud computing environment 250 may provide computation, software, data access, storage, and/or other services that do not require end-user knowledge of a physical location and configuration of system(s) and/or device(s) that host digital PMO platform 240. As shown, cloud computing environment 250 may include a group of computing resources 245 (referred to collectively as “computing resources 245” and individually as “computing resource 245”).

Computing resource 245 includes one or more personal computers, workstation computers, server devices, or another type of computation and/or communication device. In some implementations, one or more computing resources 245 may host digital PMO platform 240. The cloud resources may include compute instances executing in computing resource 245, storage devices provided in computing resource 245, data transfer devices provided by computing resource 245, etc. In some implementations, computing resource 245 may communicate with other computing resources 245 via wired connections, wireless connections, or a combination of wired and wireless connections.

As further shown in FIG. 2, computing resource 245 may include a group of cloud resources, such as one or more applications (“APPs”) 245-1, one or more virtual machines (“VMs”) 245-2, virtualized storage (“VSs”) 245-3, one or more hypervisors (“HYPs”) 245-4, or the like.

Application 245-1 includes one or more software applications that may be provided to or accessed by user device 210. Application 245-1 may eliminate a need to install and execute the software applications on user device 210 or a similar type of device. For example, application 245-1 may include software associated with digital PMO platform 240 and/or any other software capable of being provided via cloud computing environment 250. In some implementations, one application 245-1 may send/receive information to/from one or more other applications 245-1, via virtual machine 245-2.

Virtual machine 245-2 includes a software implementation of a machine (e.g., a computer) that executes programs like a physical machine. Virtual machine 245-2 may be either a system virtual machine or a process virtual machine, depending upon use and degree of correspondence to any real machine by virtual machine 245-2. A system virtual machine may provide a complete system platform that supports execution of a complete operating system (“OS”). A process virtual machine may execute a single program, and may support a single process. In some implementations, virtual machine 245-2 may execute on behalf of a user (e.g., user device 210), and may manage infrastructure of cloud computing environment 250, such as data management, synchronization, or long-duration data transfers.

Virtualized storage 245-3 includes one or more storage systems and/or one or more devices that use virtualization techniques within the storage systems or devices of computing resource 245. In some implementations, within the context of a storage system, types of virtualizations may include block virtualization and file virtualization. Block virtualization may refer to abstraction (or separation) of logical storage from physical storage so that the storage system may be accessed without regard to physical storage or heterogeneous structure. The separation may permit administrators of the storage system flexibility in how the administrators manage storage for end users. File virtualization may eliminate dependencies between data accessed at a file level and a location where files are physically stored. This may enable optimization of storage use, server consolidation, and/or performance of non-disruptive file migrations.

Hypervisor 245-4 provides hardware virtualization techniques that allow multiple operating systems (e.g., “guest operating systems”) to execute concurrently on a host computer, such as computing resource 245. Hypervisor 245-4 may present a virtual operating platform to the guest operating systems, and may manage the execution of the guest operating systems. Multiple instances of a variety of operating systems may share virtualized hardware resources.

Network 260 includes one or more wired and/or wireless networks. For example, network 260 may include a cellular network (e.g., a fifth generation (5G) network, a fourth generation (4G) network, such as a long-term evolution (LTE) network, a third generation (3G) network, a code division multiple access (CDMA) network, another type of advanced generated network, etc.), a public land mobile network (PLMN), a local area network (LAN), a wide area network (WAN), a metropolitan area network (MAN), a telephone network (e.g., the Public Switched Telephone Network (PSTN)), a private network, an ad hoc network, an intranet, the Internet, a fiber optic-based network, a cloud computing network, or the like, and/or a combination of these or other types of networks.

The number and arrangement of devices and networks shown in FIG. 2 are provided as an example. In practice, there may be additional devices and/or networks, fewer devices and/or networks, different devices and/or networks, or differently arranged devices and/or networks than those shown in FIG. 2. Furthermore, two or more devices shown in FIG. 2 may be implemented within a single device, or a single device shown in FIG. 2 may be implemented as multiple, distributed devices. Additionally, or alternatively, a set of devices (e.g., one or more devices) of environment 200 may perform one or more functions described as being performed by another set of devices of environment 200.

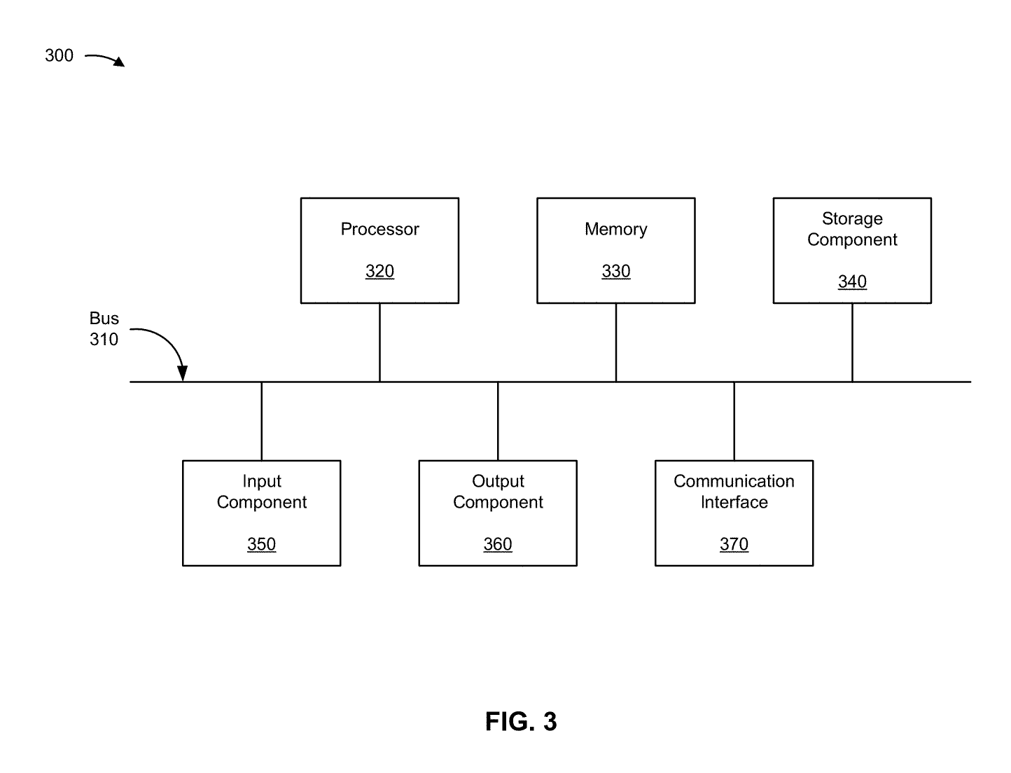

FIG. 3 is a diagram of example components of a device 300. Device 300 may correspond to user device 210, EPM system 220, dispatch center 230, and/or digital PMO platform 240. In some implementations, user device 210, EPM system 220, dispatch center 230, and/or digital PMO platform 240 may include one or more devices 300 and/or one or more components of device 300. As shown in FIG. 3, device 300 may include a bus 310, a processor 320, a memory 330, a storage component 340, an input component 350, an output component 360, and a communication interface 370.

Bus 310 includes a component that permits communication among the components of device 300. Processor 320 is implemented in hardware, firmware, or a combination of hardware and software. Processor 320 includes a central processing unit (CPU), a graphics processing unit (GPU), an accelerated processing unit (APU), a microprocessor, a microcontroller, a digital signal processor (DSP), a field-programmable gate array (FPGA), an application-specific integrated circuit (ASIC), or another type of processing component. In some implementations, processor 320 includes one or more processors capable of being programmed to perform a function. Memory 330 includes a random access memory (RAM), a read only memory (ROM), and/or another type of dynamic or static storage device (e.g., a flash memory, a magnetic memory, and/or an optical memory) that stores information and/or instructions for use by processor 320.

Storage component 340 stores information and/or software related to the operation and use of device 300. For example, storage component 340 may include a hard disk (e.g., a magnetic disk, an optical disk, a magneto-optic disk, and/or a solid state disk), a compact disc (CD), a digital versatile disc (DVD), a floppy disk, a cartridge, a magnetic tape, and/or another type of non-transitory computer-readable medium, along with a corresponding drive.

Input component 350 includes a component that permits device 300 to receive information, such as via user input (e.g., a touch screen display, a keyboard, a keypad, a mouse, a button, a switch, and/or a microphone). Additionally, or alternatively, input component 350 may include a sensor for sensing information (e.g., a global positioning system (GPS) component, an accelerometer, a gyroscope, and/or an actuator). Output component 360 includes a component that provides output information from device 300 (e.g., a display, a speaker, and/or one or more light-emitting diodes (LEDs)).

Communication interface 370 includes a transceiver-like component (e.g., a transceiver and/or a separate receiver and transmitter) that enables device 300 to communicate with other devices, such as via a wired connection, a wireless connection, or a combination of wired and wireless connections. Communication interface 370 may permit device 300 to receive information from another device and/or provide information to another device. For example, communication interface 370 may include an Ethernet interface, an optical interface, a coaxial interface, an infrared interface, a radio frequency (RF) interface, a universal serial bus (USB) interface, a Wi-Fi interface, a cellular network interface, or the like.

Device 300 may perform one or more processes described herein. Device 300 may perform these processes based on to processor 320 executing software instructions stored by a non-transitory computer-readable medium, such as memory 330 and/or storage component 340. A computer-readable medium is defined herein as a non-transitory memory device. A memory device includes memory space within a single physical storage device or memory space spread across multiple physical storage devices.

Software instructions may be read into memory 330 and/or storage component 340 from another computer-readable medium or from another device via communication interface 370. When executed, software instructions stored in memory 330 and/or storage component 340 may cause processor 320 to perform one or more processes described herein. Additionally, or alternatively, hardwired circuitry may be used in place of or in combination with software instructions to perform one or more processes described herein. Thus, implementations described herein are not limited to any specific combination of hardware circuitry and software.

The number and arrangement of components shown in FIG. 3 are provided as an example. In practice, device 300 may include additional components, fewer components, different components, or differently arranged components than those shown in FIG. 3. Additionally, or alternatively, a set of components (e.g., one or more components) of device 300 may perform one or more functions described as being performed by another set of components of device 300.

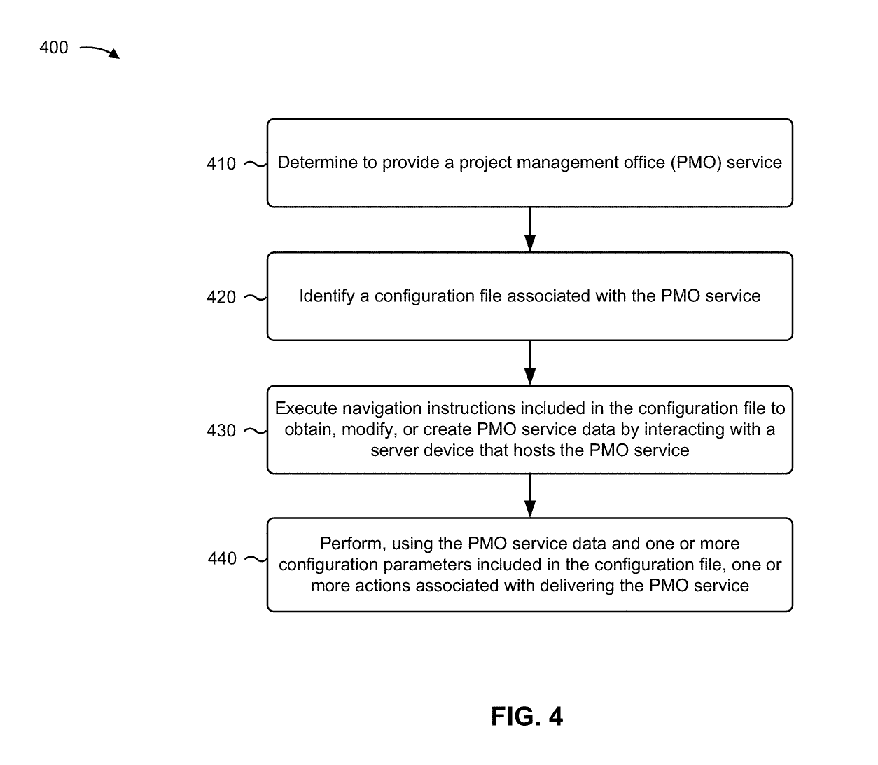

FIG. 4 is a flow chart of an example process 400 for automatically obtaining, modifying, and/or creating PMO service data as part of providing a PMO service and performing one or more actions in furtherance of the PMO service. In some implementations, one or more process blocks of FIG. 4 may be performed by digital PMO platform 240. In some implementations, one or more process blocks of FIG. 4 may be performed by another device or a group of devices separate from or including digital PMO platform 240, such as user device 210, EPM system 220, and/or dispatch center 230.

As shown in FIG. 4, process 400 may include determining to provide a project management office (PMO) service (block 410). For example, digital PMO platform 240 may determine to provide a PMO service that is associated with EPM system 220. EPM system 220 may be a tool used within an organization to manage and/or develop projects, people, products, services, and/or the like. Additionally, EPM system 220 may support a set of PMO services, such as a PMO service relating to timesheet management and compliance, risk management, report generation (e.g., a PMO service for generating reports relating to productivity, corrective or preventative actions, billing information, etc.), resource management and planning, and/or the like.

In some implementations, digital PMO platform 240 may determine to provide a PMO service based on receiving a request for the PMO service. For example, a user may interact with a user interface of user device 210 to input a request, which may be received by digital PMO platform 240. In this case, the request may include an EPM system identifier to identify the EPM system associated with the requested PMO service, a PMO service identifier to identify the PMO service requested, a request identifier to identify the request, information associated with the requested PMO service (e.g., a type or amount of data being requested, a duration for which to receive the data, a time at which to provide the data, etc.), and/or the like.

As an example, a user may interact with a user interface of user device 210 to input a request for a PMO service associated with timesheet management and compliance. For example, a business manager may input a request for timesheet information for a group of employees. In this case, the request may include a name of a requested EPM system 220 (e.g., which is used as an EPM system identifier), the requested PMO service (i.e., timesheet management and compliance), and information associated with the requested PMO service, such as information indicating a request for timesheets for a particular number of employees for a particular duration.

Additionally, dispatch center 230 may serve as an intermediary between user device 210 and digital PMO platform 240 to process requests. For example, dispatch center 230 may receive requests from a set of user devices 210, and may provide the requests to digital PMO platform 240. In this case, dispatch center 230 may process and/or prioritize the requests using a queuing technique, such as first-in first-out (FIFO), last-in first-out (LIFO), service in random order (SIRO), shortest processing time first (SPT), service according to priority (PR), or the like. Additionally, dispatch center 230 may combine requests associated with the same types of PMO services.

Additionally, or alternatively, digital PMO platform 240 may automatically interact with an interface associated with EPM system 220 (e.g., without an explicit request from user device 210). For example, digital PMO platform 240 may be configured to automatically interact with an interface associated with EPM system 220 based on a timing rule. In this case, the timing rule may indicate to interact with the interface associated with EPM system 220 at a particular time period, after a threshold time period, and/or the like.

In some implementations, digital PMO platform 240 may receive a request for PMO services associated with a set of EPM systems 220. For example, digital PMO platform 240 may support automated delivery of a set of PMO services (e.g., hundreds, thousands, etc.) that are hosted by a set of EPM systems 220 (e.g., tens, hundreds, etc.) to enable users to request a number of different PMO services associated with a number of different EPM systems 220. Additionally, interfaces of the set of PMO services may include different properties (e.g., different user interface features, such as different buttons, links, fields, etc.).

In this way, digital PMO platform 240 is able to determine to provide a PMO service.

As further shown in FIG. 4, process 400 may include identifying a configuration file associated with the PMO service (block 420). For example, digital PMO platform 240 may store a set of configuration files with information relating to a set of PMO services, and digital PMO platform 240 may analyze the set of configuration files to identify a configuration file associated with the requested PMO service.

In some implementations, digital PMO platform 240 may store a set of configuration files. For example, digital PMO platform 240 may receive a set of configuration files from a device (e.g., a device of a manager of a project management office (PMO) at a particular organization), and may store the set of configuration files for further processing. In this case, a configuration file is associated with a set of configuration parameters, such as an EPM system identifier, a PMO service identifier, navigation instructions identifying automated steps to be used to obtain, modify, and/or create PMO service data (i.e., performing robotics process automation), a set of business rules providing instructions associated with delivering the PMO service, and/or the like.

In some implementations, digital PMO platform 240 may identify a configuration file associated with the PMO service. For example, the request for the PMO service may include an EPM system identifier and a PMO service identifier, and digital PMO platform 240 may use the EPM system identifier and/or the PMO service identifier to identify a configuration file of the set of configuration files that includes a matching EPM system identifier and/or a matching PMO service identifier.

In this way, digital PMO platform 240 identifies a configuration file that may be executed to deliver the PMO service.

As further shown in FIG. 4, process 400 may include executing navigation instructions included in the configuration file to obtain, modify, or create PMO service data by interacting with a server device that hosts the PMO service (block 430). For example, digital PMO platform 240 may execute navigation instructions included in the configuration file to obtain PMO service data from EPM system 220, or to modify or create PMO service data that is stored by EPM system 220. PMO service data may include a set of values, metrics, statistics, files, and/or the like, relating to the PMO service. For example, PMO service data for a timesheet management and compliance PMO service may include timesheet data for employees of an organization, such as timesheet entries, compliance reports, and/or the like.

In some implementations, digital PMO platform 240 may obtain PMO service data. For example, digital PMO platform 240 may use an EPM path (e.g., a URL) included in the configuration file to access an interface of the PMO service. In this case, accessing the interface via the EPM path may prompt a request for a username and a password, and digital PMO platform 240 may use credential information (e.g., username, password, etc.) included in the configuration file to access the interface. In some implementations, digital PMO platform 240 may obtain PMO service data using by make one or more application programming interface (API) calls.

Additionally, digital PMO platform 240 may use the navigation instructions to interact with the interface of the PMO service. For example, the navigation instructions may include an instruction to select one or more features included within the interface (e.g., buttons, tasks, links, etc.), an instruction to provide input to the interface based on information included in the request for the PMO service, and/or the like. Furthermore, interacting with the interface of the PMO service may cause EPM system 220 to provide the PMO service data to the interface. In this case, digital PMO platform 240 may analyze the PMO service data (e.g., using a natural language processing technique) to obtain the PMO service data. For example, digital PMO platform 240 may parse the interface (e.g., values included in fields displayed on the interface) to obtain the PMO service data.

As an example, assume digital PMO platform 240 receives a request for a PMO service associated with identifying a number of users in an organization that have submitted a timesheet. In this case, digital PMO platform 240 may provide credential information (e.g., username, password, etc.) to an interface of EPM system 220 that provides a PMO service associated with identifying the number of users in an organization that have submitted a timesheet. Additionally, digital PMO platform 240 may use the navigation instructions to select, from an interface of the PMO service, a menu option requesting timesheets for a particular number of users for a particular duration, which may cause EPM system 220 to output, to the interface, a list of users that have or have not submitted a timesheet during the particular duration. In this case, digital PMO platform 240 may analyze the interface to obtain the timesheet information.

In some implementations, digital PMO platform 240 may create or modify PMO service data. For example, digital PMO platform 240 may access an interface of the PMO service using a PMO service path and credential information. In this case, digital PMO platform 240 may create or modify PMO service data by populating one or more fields of the interface based on information included in the request for the PMO service.

As an example, assume digital PMO platform 240 receives a request for a PMO service associated with modifying a record stored by EPM system 220. In this case, digital PMO platform 240 may execute navigation instructions to access an interface of EPM system 220, and may populate one or more fields of the interface based on information included in the request (e.g., information indicating what record to modify, how to modify the record, etc.). This may cause EPM system 220 to modify the record. Additionally, the created or modified record may be displayed on the interface, and digital PMO platform 240 may obtain PMO service data associated with the created or modified record using a natural language processing technique.

In this way, digital PMO platform 240 is able to automatically execute navigation instructions to obtain, create, and/or modify PMO service data.

As further shown in FIG. 4, process 400 may include performing, using the PMO service data and one or more configuration parameters included in the configuration file, one or more actions associated with delivering the PMO service (block 440). For example, digital PMO platform 240 may, using a set of business rules included in the configuration file, perform one or more actions associated with delivering the PMO service. The set of business rules may include a business rule indicating to display PMO service data in a particular manner (e.g., a particular graphical display, such as a graph, a Venn diagram, a scatter plot, a histogram, etc.), a business rule indicating to provide a reminder or a notification to one or more user devices 210 based on a condition, a business rule indicating to generate a recommendation based on identifying one or more trends associated with the PMO service data and historical PMO service data, and/or the like.

In some implementations, the set of business rules may be pre-configured by an employee of a PMO. In some implementations, one or more business rules of the set of business rules may be provided by user device 210 (e.g., via the request for the PMO service). For example, a user may interact with a user interface of user device 210 to include a particular business rule in the request for the PMO service.

In some implementations, digital PMO platform 240 may provide the PMO service data for display on a user interface. For example, digital PMO platform 240 may provide PMO service data for display on a user interface that is accessible by user device 210 (e.g., a user interface of a webpage, a user interface of an application hosted by user device 210, etc.). In this case, digital PMO platform 240 may identify a business rule indicating to display the PMO service data in a particular format, and may transform the PMO service data to a format capable of being displayed on the user interface of user device 210. Additionally, digital PMO platform 240 may provide the transformed PMO service data for display on the user interface of user device 210.

As an example, assume digital PMO platform 240 obtains PMO service data for a financial management PMO service, and that the PMO service data includes a list of billing information for a set of purchases over an interval. In this case, digital PMO platform 240 may identify a business rule indicating to display the PMO service data in a graph format, and may transform values associated with the billing information to a graphical representation of the data. In this case, digital PMO platform 240 may generate a pie chart showing a distribution of the set of the distribution of purchases over the interval.

Additionally, or alternatively, digital PMO platform 240 may provide a notification to one or more devices or accounts associated with an organization. For example, a business rule may indicate to provide a notification to one or more devices or accounts if a condition is satisfied. A condition may be pre-configured or provided by user device 210 in a request for a PMO service, and may indicate when to provide a notification (e.g., if the PMO service data satisfies a particular threshold). In this case, digital PMO platform 240 may analyze the PMO service data to determine whether the condition is satisfied, may generate the notification for the one or more user accounts based on determining that the condition is satisfied, and may provide the notification to one or more user devices associated with the one or more user accounts after determining that the condition is satisfied.

As an example, assume a business rule indicates to provide a notification to one or more user devices or user accounts if the user devices or user accounts have not submitted a timesheet within a threshold time period. Further assume that the PMO service data includes a list of users that have submitted a timesheet and/or a list of users that have not submitted a timesheet during a particular interval. In this case, digital PMO platform 240 may analyze the PMO service data to identify which user devices or user accounts have not submitted a timesheet. Additionally, if the threshold time period has passed, then digital PMO platform 240 may provide a notification (e.g., a reminder e-mail) to the one or more user devices or user accounts to aid employees of an organization with remembering to submit timesheets.

Additionally, or alternatively, digital PMO platform 240 may generate a recommendation. For example, digital PMO platform 240 may generate a recommendation based on one or more trends associated with the PMO service data and historical PMO service data (e.g., PMO service data associated with past users and entities). In this case, digital PMO platform 240 may use a forecasting technique to analyze the PMO service data and/or the historical PMO service data, and may identify one or more trends based on the analysis. For example, digital PMO platform 240 may execute a forecasting technique that analyzes historical PMO service data over an interval to search for trends, such as similarities and/or patterns within the data. Moreover, digital PMO platform 240 may execute a forecasting technique such as a time series method, an artificial intelligence-based method, an average approach, a naïve approach, a drift method, a seasonal naïve approach, or the like.

Additionally, digital PMO platform 240 may generate a recommendation based on a business rule and/or identifying the trend. For example, assume a business rule indicates to generate a particular recommendation if a condition associated with a negative action (e.g., failing to submit a timesheet) is satisfied. Further assume that digital PMO platform 240 executes a forecasting technique to identify a trend indicating that a set of user devices regularly perform the negative action. In this case, digital PMO platform 240 may generate a recommendation for the one or more devices to provide a recommendation to perform a positive action (e.g., submit a timesheet in a timely fashion). Furthermore, digital PMO platform 240 may analyze user profiles for an organization, and may generate the recommendation for one or more user profiles with similar characteristics as the characteristics associated with the one or more devices. Additionally, digital PMO platform 240 may provide the recommendation to the one or more devices (e.g., user device 210 or a similar type of device).

As an example, assume digital PMO platform 240 analyzes the PMO service data and/or historical PMO service data to identify a trend showing a subset of user accounts that frequently fail to submit timesheets in a timely fashion. In this case, digital PMO platform 240 may generate a recommendation or a notification (e.g. an e-mail) to remind the subset of users to submit timesheets, and may provide the recommendation to user devices prior to the timesheet submission deadline.

Additionally, or alternatively, digital PMO platform 240 may use a data model to generate and provide a recommendation to user device 210. For example, digital PMO platform 240 may provide PMO service data as input for a data model to cause the data model to output a value associated with classifying the PMO service data. In this case, the data model may have been trained using historical PMO service data. Additionally, the output of the data model may be used to classify the PMO service data into a class (e.g., of a set of classes), and the class may dictate a type of recommendation to generate. For example, a class may dictate a type of recommendation to generate by associating positive actions with particular classes and by associating negative actions with particular classes. Additionally, digital PMO platform 240 may generate a recommendation based on the classification of the PMO service data, and may provide the recommendation to user device 210.

In this way, digital PMO platform 240 is able to perform actions associated with delivering the PMO service.

Although FIG. 4 shows example blocks of process 400, in some implementations, process 400 may include additional blocks, fewer blocks, different blocks, or differently arranged blocks than those depicted in FIG. 4. Additionally, or alternatively, two or more of the blocks of process 400 may be performed in parallel.

In this way, digital PMO platform 240 conserves processing resources and/or network resources by providing efficient PMO services (e.g., relative to manual execution of PMO services, of which human error may lead to resources spent on re-execution of PMO services, resources spent on error correction techniques, etc.), conserves memory resources by reducing data redundancy across PMO services, improves business process turnaround time, reduces cost, improves scalability, and/or the like.

The foregoing disclosure provides illustration and description, but is not intended to be exhaustive or to limit the implementations to the precise form disclosed. Modifications and variations are possible in light of the above disclosure or may be acquired from practice of the implementations.

As used herein, the term component is intended to be broadly construed as hardware, firmware, and/or a combination of hardware and software.

Some implementations are described herein in connection with thresholds. As used herein, satisfying a threshold may refer to a value being greater than the threshold, more than the threshold, higher than the threshold, greater than or equal to the threshold, less than the threshold, fewer than the threshold, lower than the threshold, less than or equal to the threshold, equal to the threshold, or the like.

It will be apparent that systems and/or methods, described herein, may be implemented in different forms of hardware, firmware, or a combination of hardware and software. The actual specialized control hardware or software code used to implement these systems and/or methods is not limiting of the implementations. Thus, the operation and behavior of the systems and/or methods were described herein without reference to specific software code—it being understood that software and hardware can be designed to implement the systems and/or methods based on the description herein.

Even though particular combinations of features are recited in the claims and/or disclosed in the specification, these combinations are not intended to limit the disclosure of possible implementations. In fact, many of these features may be combined in ways not specifically recited in the claims and/or disclosed in the specification. Although each dependent claim listed below may directly depend on only one claim, the disclosure of possible implementations includes each dependent claim in combination with every other claim in the claim set.

No element, act, or instruction used herein should be construed as critical or essential unless explicitly described as such. Also, as used herein, the articles “a” and “an” are intended to include one or more items, and may be used interchangeably with “one or more.” Furthermore, as used herein, the term “set” is intended to include one or more items (e.g., related items, unrelated items, a combination of related and unrelated items, etc.), and may be used interchangeably with “one or more.” Where only one item is intended, the term “one” or similar language is used. Also, as used herein, the terms “has,” “have,” “having,” or the like are intended to be open-ended terms. Further, the phrase “based on” is intended to mean “based, at least in part, on” unless explicitly stated otherwise.

What is claimed is:

1. A device, comprising:
one or more processors to:
receive requests for a set of project management office (PMO) services that are hosted by a set of enterprise project management (EPM) systems,
wherein the requests include a first request and the first request includes a PMO service identifier, and
wherein interfaces of the set of PMO services include different properties;
analyze a set of configuration files to identify a configuration file associated with a PMO service of the set of PMO services that is associated with the first request,
the configuration file being associated with the PMO service identifier;
execute navigation instructions included in the configuration file to obtain, modify, or create PMO service data by interacting with a server device that hosts the PMO service; and
perform, using the PMO service data and one or more configuration parameters included in the configuration file, one or more actions associated with delivering the PMO service.

2. The device of claim 1, where the configuration file is associated with at least one of:
the PMO service identifier,
an EPM system identifier,
the navigation instructions, or
a set of business rules providing instructions associated with delivering the PMO service.

3. The device of claim 1, where the one or more processors, when executing the navigation instructions, are to:
access an interface associated with the PMO service using a PMO service path and credential information included in the navigation instructions, and
interact with the interface of the PMO service using the navigation instructions,
the navigation instructions including at least one of:
an instruction to populate one or more fields of the interface based on information included in the first request, or
an instruction to select one or more features of the interface,
the navigation instructions causing the server device to provide the PMO service data for display on the interface, and
analyze the interface to obtain the PMO service data.

4. The device of claim 1, where the one or more processors, when executing the navigation instructions, are to:
access an interface associated with the PMO service using a PMO service path and credential information included in the navigation instructions, and
interact with the interface of the PMO service using the navigation instructions,
the navigation instructions including an instruction to populate one or more fields of the interface based on information included in the first request, and
the navigation instructions causing a record stored by the server device to be created, updated, or deleted.

5. The device of claim 1, where the one or more processors, when executing the navigation instructions, are to:
execute the navigation instructions to create or modify a record stored by the server device; and
where the one or more processors, when performing the one or more actions, are to:
provide a notification to a user device that the record has been created or modified.

6. The device of claim 1, where the one or more processors, when performing the one or more actions, are to:
transform, using a business rule included in the configuration file, the PMO service data to a format capable of being displayed on a user interface of a user device,
the business rule including instructions allowing the device to transform the PMO service data to the format capable of being displayed on the user interface of the user device, and
provide the transformed PMO service data for display on the user interface of the user device.

7. The device of claim 1, where the one or more processors, when performing the one or more actions, are to:
analyze the PMO service data using a business rule included in the configuration file,
the business rule including instructions indicating to generate a notification for one or more user accounts if a condition is satisfied,
generate the notification for the one or more user accounts based on determining that the condition is satisfied, and
provide the notification to one or more user devices associated with the one or more user accounts.

8. A method, comprising:
determining, by a device, to provide a project management office (PMO) service,
the PMO service being one of a set of PMO services that are hosted by a set of enterprise project management (EPM) systems,
wherein interfaces of the set of PMO services include different properties;
analyzing, by the device, a set of configuration files to identify a configuration file associated with the PMO service;
executing, by the device, navigation instructions included in the configuration file to obtain, modify, or create PMO service data by interacting with a server device that hosts the PMO service; and
performing, by the device and by using the PMO service data and one or more configuration parameters included in the configuration file, one or more actions associated with delivering the PMO service.

9. The method of claim 8, where determining to provide the PMO service comprises:
receiving, from a set of user devices, requests for the set of PMO services,
wherein the requests include a first request and the first request includes a PMO service identifier; and
where analyzing the set of configuration files comprises:
analyzing the set of configuration files to identify the configuration file associated with the PMO service,
the configuration file including a PMO service identifier that matches the PMO service identifier included in the first request.

10. The method of claim 8, where determining to provide the PMO service comprises:
determining to provide the PMO service based on a timing rule,
the timing rule indicating to provide the PMO service at a particular time period or after a threshold time period.

11. The method of claim 8, where executing the navigation instructions comprises:
accessing an interface associated with the PMO service using the navigation instructions,
the navigation instructions including an instruction to access a uniform resource locator (URL) associated with the PMO service, and
interacting with the interface using the navigation instructions,
the navigation instructions including at least one of an instruction to populate one or more fields of the interface or an instruction to select a feature included within the interface,
the navigation instructions causing the server device to provide the PMO service data for display on the interface, and
analyzing the interface using a natural language processing technique to obtain the PMO service data.

12. The method of claim 8, where executing the navigation instructions comprises:
accessing an interface associated with the PMO service using the navigation instructions,
the navigation instructions including an instruction to populate one or more fields of the interface based on information included in a request for the PMO service, and
the navigation instructions causing a record stored by the server device to be created, updated, or deleted.

13. The method of claim 8, where executing the navigation instructions comprises:
executing the navigation instructions to obtain the PMO service data; and
where performing the one or more actions comprises:
transforming, using a business rule included in the configuration file, the PMO service data to a format capable of being displayed on a user interface of a user device,
the business rule including instructions allowing the device to transform the PMO service data to the format capable of being displayed on the user interface of the user device, and
providing the transformed PMO service data for display on the user interface of the user device.

14. The method of claim 8, further comprising:
analyzing, after performing the one or more actions, historical PMO service data and the PMO service data;
identifying one or more trends based on analyzing the historical PMO service data and the PMO service data;
generating a recommendation based on identifying the one or more trends; and
providing the recommendation to a user device.

15. A non-transitory computer-readable medium storing instructions, the instructions comprising:
one or more instructions that, when executed by one or more processors, cause the one or more processors to:
receive requests for a set of project management office (PMO) services that are hosted by a set of enterprise project management (EPM) systems,
where the requests include a first request and the first request includes a PMO service identifier,
analyze a set of configuration files to identify a configuration file associated with a PMO service of the set of PMO services that is associated with the first request,
the configuration file being associated with the PMO service identifier;
execute navigation instructions included in the configuration file to obtain, modify, or create PMO service data by interacting with a server device that hosts the PMO service; and
perform, using the PMO service data and one or more configuration parameters included in the configuration file, one or more actions associated with delivering the PMO service.

16. The non-transitory computer-readable medium of claim 15, where interfaces of the set of PMO services include different properties.

17. The non-transitory computer-readable medium of claim 15, where the one or more instructions, that cause the one or more processors to execute the navigation instructions, cause the one or more processors to:
interact with an interface associated with the PMO service using the navigation instructions,
the navigation instructions including an instruction to populate one or more fields the interface based on information included in the first request, and
the navigation instructions causing a record stored by the server device to be created, updated, or deleted.

18. The non-transitory computer-readable medium of claim 15, where the one or more instructions, that cause the one or more processors to perform the one or more actions, cause the one or more processors to:
transform, using a business rule included in the configuration file, the PMO service data to a format capable of being displayed on a user interface of a user device,
the business rule including instructions allowing the PMO service data to be transformed to the format capable of being displayed on the user interface of the user device, and
provide the PMO service data that has been transformed for display on the user interface of the user device.

19. The non-transitory computer-readable medium of claim 15, where the one or more actions include at least one of:
an action to transform the PMO service data to a format capable of being displayed on a user interface,
an action to generate a notification for one or more user accounts if a condition is satisfied, or
an action to generate a recommendation based on identifying one or more trends associated with the PMO service data and historical PMO service data.

20. The non-transitory computer-readable medium of claim 15, where the one or more instructions, that cause the one or more processors to perform the one or more actions, cause the one or more processors to:
provide the PMO service data as input for a data model to cause the data model to output a value associated with classifying the PMO service data,
the data model having been trained using historical PMO service data,
generate a recommendation based on the classification of the PMO service data, and provide the recommendation to a user device.
